(19) United States
(12) Patent Application Publication
(10) Pub. No.: US 2025/0056287 A1
(43) Pub. Date: Feb. 13, 2025

(54) REPORTING AND ACQUISITION OF DEVICE CAPABILITY INFORMATION

(71) Applicant: Beijing Xiaomi Moblie Software Co., Ltd., Beijing (CN)

(72) Inventors: Min LIU, Beijing (CN); Juan ZHANG, Beijing (CN)

(73) Assignee: Beijing Xiaomi Moblie Software Co., Ltd., Beijing (CN)

(21) Appl. No.: 18/722,683

(22) PCT Filed: Dec. 31, 2021
(86) PCT No.: PCT/CN2021/144071

§ 371 Date: Jun. 21, 2024

(51) Int. Cl. H04W 24/10; H04W 72/0453

(52) U.S. Cl. CPC H04W 24/10; H04W 72/0453

(57) ABSTRACT

A method for reporting device capability information is performed by a smart repeater. The method includes: sending device capability information to a network device, where the device capability information indicates frequency response capability of the smart repeater and includes one or more groups of frequency response parameters.

### CROSS-REFERENCE TO RELATED APPLICATION

The present application is a U.S. National Stage of International Application No. PCT/CN2021/144071, filed on Dec. 31, 2021, the contents of which are incorporated herein by reference in their entirety.

### TECHNICAL FIELD

The present disclosure relates to the field of mobile communication technologies, and in particular, to reporting and acquisition of device capability information.

### BACKGROUND

With the development of communication network, a network-controlled repeater, which can also be named as a smart repeater or a repeater that directionally amplifies signals, is expected to become a key technology for expanding cell coverage. A downlink signal of a base station is received by a user equipment (UE) through an amplification of the smart repeater, and accordingly, an uplink signal of the UE is received by the base station through an amplification of the smart repeater.

The number of usable carrier units and a frequency range of a signal amplified by a smart repeater are affected by a device capability of the smart repeater, so it is urgent to know the device capability information of smart repeater.

### SUMMARY

The present disclosure provides methods and apparatus for reporting device capability information. smart repeater can report its device capability information to network device, so that network device can allocate appropriate communication resources to user equipment according to the device capability information of smart repeater.

An embodiment of a first aspect of the present disclosure provides a method for reporting device capability information, the method being performed by a smart repeater, and including: sending device capability information to a network device, where the device capability information indicates frequency response capability of the smart repeater and includes one or more groups of frequency response parameters.

An embodiment of a second aspect of the present disclosure provides a method for acquiring device capability information, the method being performed by a network device, and including: receiving device capability information reported by a smart repeater, where the device capability information indicates frequency response capability of the smart repeater and includes one or more groups of frequency response parameters.

An embodiment of a third aspect of the present disclosure provides a communication device, including: a transceiver; a memory; a processor, connected to the transceiver and the memory, respectively, and configured to control radio signal transmission and reception of the transceiver by executing computer-executable instructions on the memory, and configured to: send device capability information to a network device, where the device capability information indicates frequency response capability of the smart repeater and includes one or more groups of frequency response parameters.

### BRIEF DESCRIPTION OF DRAWINGS

The above-mentioned and/or additional aspects and advantages of the present disclosure will be apparent and easily understood from the following description of embodiments taken in conjunction with accompanying drawings.

FIG. 1 is a schematic architectural diagram of a communication system according to an embodiment of the present disclosure.

FIG. 2 is a flowchart of a method for reporting device capability information according to an embodiment of the present disclosure.

FIG. 3 is a flowchart of a method for reporting device capability information according to an embodiment of the present disclosure.

FIG. 4 is a flowchart of a method for reporting device capability information according to an embodiment of the present disclosure.

FIG. 5 is a flowchart of a method for reporting device capability information according to an embodiment of the present disclosure.

FIG. 6 is a flowchart of a method for reporting device capability information according to an embodiment of the present disclosure.

FIG. 7 is a flowchart of a method for reporting device capability information according to an embodiment of the present disclosure.

FIG. 8 is a flowchart of a method for reporting device capability information according to an embodiment of the present disclosure.

FIG. 9 is a flowchart of a method for reporting device capability information according to an embodiment of the present disclosure.

FIG. 10 is a flowchart of a method for acquiring device capability information according to an embodiment of the present disclosure.

FIG. 11 is a flowchart of a method for acquiring device capability information according to an embodiment of the present disclosure.

FIG. 12 is a flowchart of a method for acquiring device capability information according to an embodiment of the present disclosure.

FIG. 13 is a flowchart of a method for acquiring device capability information according to an embodiment of the present disclosure.

FIG. 14 is a flowchart of a method for acquiring device capability information according to an embodiment of the present disclosure.

FIG. 15 is a flowchart of a method for acquiring device capability information according to an embodiment of the present disclosure.

FIG. 16 is a flowchart of a method for acquiring device capability information according to an embodiment of the present disclosure.

FIG. 17 is a flowchart of a method for acquiring device capability information according to an embodiment of the present disclosure.

FIG. 18 is a block diagram of an apparatus for reporting device capability information according to an embodiment of the present disclosure.

FIG. 19 is a block diagram of an apparatus for acquiring device capability information according to an embodiment of the present disclosure.

FIG. 20 is a schematic structural diagram of a communication apparatus according to an embodiment of the present disclosure.

FIG. 21 is a schematic structural diagram of a chip according to an embodiment of the present disclosure.

### DETAILED DESCRIPTION

Hereinafter, embodiments of the present disclosure will be described in detail, examples of which are illustrated in the accompanying drawings, where the same or similar reference numerals from beginning to end indicate the same or similar components or components having the same or similar functions throughout. Embodiments described below by referring to the accompanying drawings are examples and are intended to explain the present disclosure, and should not be construed as limiting the present disclosure.

In order to better understand the methods and apparatuses for reporting device capability information disclosed in embodiments of the present disclosure, a communication system applicable to the embodiments of the present disclosure will be described below.

The technical solutions of the embodiments of the present disclosure can be applied to various communication systems. For example: a long term evolution (LTE) system, a 5th generation (5G) mobile communication system, a 5G new radio (NR) system, or other future new mobile communication systems.

In the present disclosure, a carrier, from a perspective of a physical layer, can be used as a carrier for carrying information. The carrier occupies a certain frequency range (e.g., a frequency range characterized by a center frequency point and a bandwidth). A cell, from a perspective of high-level resource management, can be a unit that manages wireless communication. A cell may include a carrier. According to different duplex modes, a downlink carrier and an uplink carrier of a cell can be different (as in a frequency division duplex (FDD) system), and a downlink carrier and an uplink carrier of a cell can also be the same (as in a time division duplex (TDD) system). In carrier aggregation/dual link, some cells can contain both downlink carriers and uplink carriers, and some cells can only contain downlink carriers. Interference can be avoided between cells with the same carrier by deploying different azimuth angles in the cells.

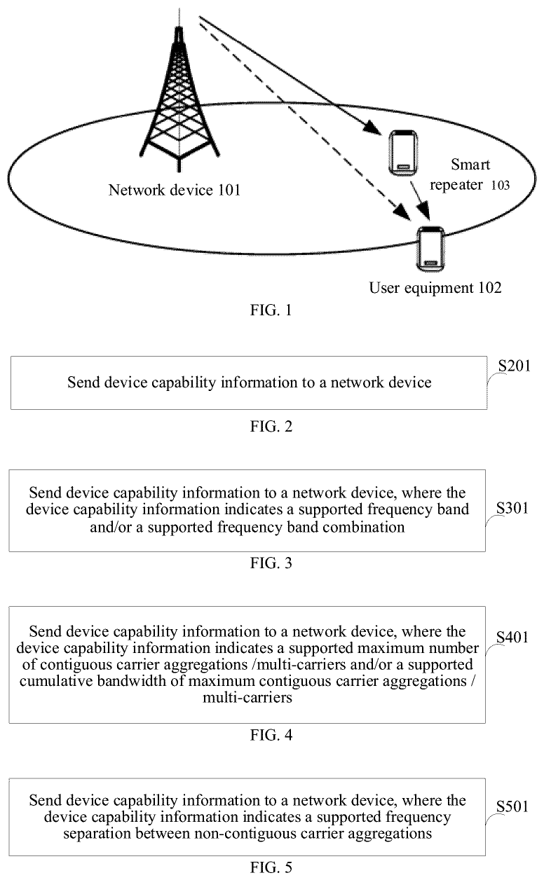

Referring to FIG. 1, FIG. 1 is a schematic architectural diagram of a communication system according to an embodiment of the present disclosure. The communication system may include but is not limited to a network device, a user equipment and a smart repeater. The number and form of devices shown in FIG. 1 are only for example and do not constitute a limitation to the embodiments of the present disclosure. In practical application, it may include two or more network devices, two or more user equipment, and two or more smart repeaters. The communication system shown in FIG. 1 includes a network device 101, a user equipment 102 and a smart repeater 103 as an example.

The network device 101 can communicate with the user equipment 102 through the smart repeater 103. The network device 101 and the smart repeater 103 can communicate through a wireless communication interface, such as an LTE Uu port or an NR Uu port. The LTE Uu port or NR Uu port can refer to a wireless communication interface between a radio access network (RAN) device and a terminal device in a cellular communication system. The smart repeater 103 and the user equipment 102 can communicate through a wireless direct communication interface, such as a PC5 port. The PC5 port can refer to a wireless communication interface for direct communication between terminal devices, and through the PC5 port, terminal devices can interact with each other directly without forwarding data through a cellular communication network. The smart repeater 103 and the user equipment 102 can communicate via microwave, WiFi or Bluetooth. The network device 101 may further communicate directly with the user equipment 102 via a wireless communication interface. It should be noted that the network architecture shown in FIG. 1 is only an example architectural diagram, and in addition to the network functional entities shown in FIG. 1, the communication system shown in FIG. 1 may further include other functional entities, such as: core network elements, more user equipment, or relay equipment, etc., which are not limited by the present disclosure. In addition, FIG. 1 is an example of the user equipment 102 being at an edge of or outside a coverage area of the network device 101, and the user equipment 102 may also be at the edge of or within the coverage area of the network device 101. For example, there may be no suitable communication resources between the user equipment 102 and the network device 101, or the communication resources between the user equipment 102 and the network device 10 are not as good as the communication resources between the smart repeater 103 and the network device 10 (e.g., quality of communication resources can be measured by channel quality). At this time, the user equipment 102 can realize communication with the network device 10 through the smart repeater 103.

The network device 101 of FIG. 1 is an entity on a network side for transmitting or receiving signals. For example, the network device 101 may be an evolved NodeB (eNB), a transmission reception point (TRP), a next generation NodeB (gNB) in an NR system, a base station in other future mobile communication systems or an access node in a wireless fidelity (WiFi) system. The embodiments of the present disclosure do not limit specific technologies and specific device forms adopted by the network device. The network device provided by the embodiment of the present disclosure may be composed of a central unit (CU) and a distributed unit (DU), where CU may also be named as a control unit. With a structure of CU-DU, protocol layers of a network device, such as a base station, can be separated, and some functions of the protocol layers are centralized controlled by CU, while some or all functions of the remaining protocol layers are distributed in DU, which is centralized controlled by CU.

The user equipment 102 in FIG. 1 is an entity, such as a mobile phone, on a user side for receiving or transmitting signals. The user equipment (UE) can also be named as a terminal, a mobile station (MS), a mobile terminal equipment (MT) and so on. The user equipment can be a car with communication function, a smart car, a mobile phone, a wearable device, a Pad, a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present disclosure do not limit specific technologies and specific device forms adopted by the user equipment.

The smart repeater 103 in FIG. 1 can be any network device that can at least directionally amplify signals, or a terminal device with a function of directionally amplifying signals. The smart repeater can be named as “network-controlled repeater”, “repeater capable of directionally amplifying signals”, “smart relay device”, “network-assisted repeater”, “controllable repeater” and so on, hereinafter referred to as “smart repeater”.

Reconfigurable intelligent surface (RIS) can also be called “reconfigurable intelligence surface” or “smart reflective surface”. From the outside, the RIS is an ordinary thin sheet. However, it can be flexibly deployed in a wireless communication propagation environment, and realize manipulation of frequency, phase, polarization and other characteristics of reflected or refracted electromagnetic waves, thus achieving a purpose of reshaping a wireless channel. Specifically, RIS can reflect a signal incident on its surface to a specific direction through precoding technology, thus enhancing the signal strength at a receiving end and realizing a control of a channel.

Since a smart repeater and an RIS have similar characteristics when interacting with the network, in the present disclosure, the smart repeater refers to the smart repeater and RIS.

The smart repeater 103 in the embodiment of the present disclosure is an entity between the network device 101 and the terminal device 102 for transmitting or receiving signals. For example, the smart repeater 103 may be a network unit, a terminal device with relay function, or a reconfigurable intelligent surface (RIS). The embodiments of the present disclosure do not limit specific technologies and specific device forms adopted by the smart repeater.

It is to be understood that the communication system described in the embodiments of the present disclosure is intended to more clearly illustrate the technical solutions of the embodiments of the present disclosure and does not constitute a limitation of the technical solutions provided by the embodiments of the present disclosure, and a person of ordinary skill in the art may know that, with an evolution of a system architecture and an emergence of a new business scenario, the technical solutions provided by the embodiments of the present disclosure are equally applicable to similar technical problems.

The number of usable carrier units and a frequency range of a signal amplified by a smart repeater are affected by a device capability of the smart repeater, so it is urgent to know the device capability information of smart repeater.

Therefore, the present disclosure provides methods and apparatus for reporting device capability information. Smart repeater can report its device capability information to network device, so that network device can allocate appropriate communication resources to user equipment according to the device capability information of smart repeater.

The methods and apparatuses for reporting equipment capacity information provided in the present disclosure are described in detail below in conjunction with the accompanying drawings.

FIG. 2 shows a flowchart of a method for reporting device capability information according to an embodiment of the present disclosure. As shown in FIG. 2, the method can be performed by a smart repeater and includes the following step S201.

At step S201, device capability information is sent to a network device, where the device capability information indicates frequency response capability of the smart repeater and includes one or more groups of frequency response parameters.

In the present disclosure, the smart repeater may send its device capability information to the network device, so that the network device can allocate appropriate communication resources for a network device that forwards signals through the smart repeater based on the smart repeater.

The device capability information of the smart repeater is used to indicate the frequency response capability of the smart repeater, and may include at least one group of frequency response parameters. The frequency response capability can also reflect a carrier aggregation capability of smart repeater.

In some embodiments, each of the groups of frequency response parameters includes at least one of the following frequency-related parameters: a supported frequency band; a supported frequency band combination; a supported maximum number of contiguous carrier aggregations; a supported maximum cumulative bandwidth of contiguous carrier aggregations; a supported frequency separation between non-contiguous carrier aggregations; a supported passband; or a supported frequency shifting capability.

In some embodiments, the frequency-related parameter is indicated by one or more fixed values or range values.

For example, the smart repeater can report a group of frequency response parameters to the network device, including one or more of the following frequency-related parameters, 1-7.

### 1. A Supported Frequency Band

The supported frequency band can be indicated by, for example, an NR frequency band number, and this parameter can be defined for each frequency band (per band), and this parameter can be mandatory to report.

The supported frequency band can be indicated by one or more fixed values, such as (frequency) band numbers 1, 11, 21. Or, the supported frequency band can also be indicated by one or more range values, such as all frequency bands with band numbers less than 20, and all frequency bands with band numbers greater than 30 but less than 40.

### 2. A Supported Frequency Band Combination

Similar to the supported frequency band, this parameter can be defined for per band, and this parameter can be mandatory to report.

The supported frequency band combination can also be indicated by one or more range values, such as frequency band combination 1, frequency band combination 2 and frequency band combination 4. Where frequency band combination 1 indicates {frequency band 1-frequency band 5}, frequency band combination 2 indicates {frequency band 11-frequency band 15}, and frequency band combination 4 indicates {frequency band 31-frequency band 35}.

### 3. A Supported Maximum Number of Contiguous Carrier Aggregations/Multi-Carriers

This parameter can be defined for per band, indicating a maximum carrier aggregation number that can be continuously scheduled on per band, and this parameter may not be mandatory to report.

The supported maximum number of contiguous carrier aggregations can be indicated by a fixed value, for example, 8.

### 4. A Supported Maximum Cumulative Bandwidth of Contiguous Carrier Aggregations/Multi-Carriers

Similar to the supported maximum number of contiguous carrier aggregations, this parameter can be defined for per band, indicating a maximum carrier aggregation bandwidth that can be continuously scheduled on per band, and this parameter may not be mandatory to report.

The supported maximum cumulative bandwidth of carrier aggregations can be indicated by a fixed value, such as 800 MHz (Mega Hertz). Or, the supported maximum cumulative bandwidth of carrier aggregations can be indicated by a range value. For example, a number of different classes can be predefined, for example, class A indicates 0-400 MHz, class B indicates 400 MHz-800 MHz, and class C indicates 800 MHz-1200 MHz. When the supported maximum cumulative bandwidth of carrier aggregations is indicated by class B, it indicates that the supported maximum cumulative bandwidth of carrier aggregations is 800 MHz, and a base station can realize continuous carrier scheduling between 400 MHz and 800 MHz.

### 5. A Supported Frequency Separation Between Non-Contiguous Carrier Aggregations

This parameter can be defined for each frequency band in each frequency band combination (per band combination) or for per feature set, and the parameter can be not mandatory to report or conditionally mandatory to report (i.e., mandatory to report under certain conditions), e.g., the smart repeater can include mobile terminal part and repeater part, and for the repeater part of the smart repeater, the parameter is mandatory to report. In addition, this parameter can distinguish FR1 frequency band and FR2 frequency band, where FR1 frequency band and FR2 frequency band are two main frequencies used in 5G networks. A frequency range of FR1 band is 450 MHz-6 GHz (Giga Hertz), also known as a band below 6 GHz, while a frequency range of FR2 band is 24.25 GHz-52.6 GHz, which is usually named as millimeter wave. For example, for the FR1 frequency band, this parameter can be indicated by a range value, e.g., a plurality of different classes can be predefined, for example, class 1 indicates that a frequency separation between non-contiguous carrier aggregations is less than or equal to 100 MHz, class 2 indicates that a frequency separation between non-contiguous carrier aggregations is more than 100 MHz and less than or equal to 200 MHz, class 3 indicates that a frequency separation between non-contiguous carrier aggregations is greater than 200 MHz and less than or equal to 600 MHz, and when a supported frequency separation between non-contiguous carrier aggregations is indicated by class 3, it indicates that the supported frequency separation between non-contiguous carrier aggregations is greater than 200 MHz and less than or equal to 600 MHz. For another example, for the FR2 frequency band, this parameter can be indicated by a fixed value, which refers to a frequency separation between a lower frequency edge of a carrier unit (carrier component) corresponding to a minimum frequency and an upper frequency edge of a carrier unit corresponding to a maximum frequency in the non-contiguous carrier aggregation, e.g., 2 GHz.

### 6. A Supported Passband

This parameter can be defined for each frequency band in each frequency band combination (per band combination) or for per feature set, and the parameter can be not mandatory to report or conditionally mandatory to report (i.e., mandatory to report under certain conditions), e.g., for the repeater part of the smart repeater, the parameter is mandatory to report.

The supported passband (range) may be indicated by one or more range values, for example, passband 1, passband 2. The passband 1 indicates a frequency band range of 400 MHz-800 MHz, and the passband 2 indicates a frequency band range of 2.5 GHz-4.3 GHz.

### 7. A Supported Frequency Shifting Capability

This parameter can be defined for each frequency band or each frequency range in per band combination, and the parameter can be not mandatory to report or conditionally mandatory to report (i.e., mandatory to report under certain conditions), e.g., for the repeater part of the smart repeater, the parameter is mandatory to report.

In some embodiments, the supported frequency shifting capability includes at least one of the following: information indicating that the smart repeater performs frequency modulation in-band or out-of-band; information indicating an adjustable frequency range of the smart repeater; or information indicating a frequency modulation step size of the smart repeater.

For example, the information indicating that the smart repeater performs frequency modulation in-band or out-of-band can be indicated by in-band frequency modulation or out-of-band frequency modulation, where in-band frequency modulation indicates that the smart repeater can only perform frequency modulation and amplification on an input signal in the same frequency band, while out-of-band frequency modulation indicates that the smart repeater can perform frequency modulation and amplification on an input signal in different frequency bands.

The information indicating the adjustable frequency range of smart repeater can be represented by one or more fixed values, such as +m MHz and −n MHz, which means that a maximum up-chirp is m MHz and a maximum down-chirp is n MHz, that is, an adjustable frequency range is [f0−n, f0+m], where f0 is a frequency to be adjusted. For another example, a frequency modulation step size can be predefined as S MHz, and the information indicating the adjustable frequency modulation range of smart repeater can be indicated by integers n1 and n2, which means that an adjustable frequency modulation range is [f0+n1*S, f0+n2*S]. Or, the information indicating the adjustable frequency range of the smart repeater can also be represented by a range value, such as m1-m2 MHz, which means that the adjustable frequency range is [f0+m1, f0+m2].

The information indicating the frequency modulation step size of the smart repeater may be indicated by a fixed value, for example, 200 MHz.

In some embodiments, each of the groups of frequency response parameters further includes one or more power-related parameters, and the one or more power-related parameters include at least one of following parameters: a supported transmission power class; a supported maximum transmission power value; a supported target receiving power value; or a supported target receiving power class.

In addition to the above-mentioned frequency-related parameters, the smart repeater can further report power-related parameters to the network device.

For example, the smart repeater may report a group of frequency response parameters to the network device, which may include one or more of the following power-related parameters in addition to the above-mentioned frequency-related parameters.

### 1. A Supported Transmission Power Class

This parameter can be defined for per band, and it may not be mandatory to report. This parameter can distinguish between FR1 (frequency) band and FR2 (frequency) band.

For example, for the FR1 frequency band, the supported transmission power class can be indicated by power classes (PC) such as PC2 and PC3, where PC2 indicates a maximum transmission power is 26 dBm, and PC3 indicates a maximum transmission power is 23 dBm. For the FR2 frequency band, the supported transmission power class can be indicated by power classes such as PC1, PC2, PC3 and PC4. Considering that high frequency bands will perform beamforming to improve directional power, each PC can further contain parameters related to beamforming, e.g., min peak equivalent isotropically radiated power (min peak EIRP), maximum equivalent isotropically radiated power (Max EIRP) and Spherical Coverage, such as min peak EIRP=22 dB, Max EIRP=26 dB and Spherical Coverage=11 dB.

### 2. A Supported Maximum Transmission Power Value

The maximum supported maximum transmission power value can be indicated by a fixed value, for example, 23 dBm. It can also be indicated by a group of transmission power values, such as min peak EIRP=22 dB, Max EIRP=26 dB, and Spherical Coverage=11 dB.

### 3. A Supported Target Receiving Power Value

This parameter can be not mandatory to report or conditionally mandatory to report (i.e., mandatory to report under certain conditions), e.g., for the repeater part of the smart repeater, the parameter is mandatory to report.

The supported target receiving power value can be indicated by a fixed value, such as −140 dBm, and can further be indicated by a target receiving power spectral density value, such as −140 dBm/MHz.

### 4. A Supported Target Receiving Power Class

This parameter can be not mandatory to report or conditionally mandatory to report (i.e., mandatory to report under certain conditions), e.g., for the repeater part of the smart repeater, the parameter is mandatory to report.

Similar to the supported transmission power class, the supported target receiving power class may be indicated by a predefined power class.

In some embodiments, the smart repeater may not report the frequency-related parameters to the network device. In this case, a supported transmission power value may be considered as a default power value, which may be a maximum transmission power of the smart repeater.

In some embodiments, the supported transmission power class indicates a maximum transmission power that is not greater than respective maximum transmission powers of other user equipment in a cell to which the smart repeater belongs.

In order not to cause interference to other user equipment in the cell to which the smart repeater belongs, the supported maximum transmission power value of the smart repeater should not exceed the maximum power of other user equipment in the cell.

In some embodiments, the smart repeater includes a mobile terminal part and a repeater part, and the one or more groups of frequency response parameters includes more than one group of frequency response parameters, where at least one group in the more than one group of frequency response parameters is configured for the mobile terminal part and at least another group in the more than one group of frequency response parameters is configured for the repeater part.

The smart repeater can include a mobile terminal part and a repeater part, so that the smart repeater can respectively report capability information related to the mobile terminal part and capability information related to the repeater part to the network device. For example, the smart repeater can report at least one group of frequency response parameters related to the repeater part and at least one group of frequency response parameters related to the mobile terminal part to the network device. Each group of reported frequency response parameters may include one or more of the above frequency-related parameters, and may further include one or more of the above power-related parameters. For the mobile terminal part, there is no need to report the supported frequency shifting capability and supported passband.

According to the method of reporting device capability information of embodiments of the present disclosure, the smart repeater reports device capability information indicating its frequency response capability to the network device, so that the network device, when allocating communication resources for user equipment, can sufficiently consider the frequency response capability of the smart repeater through which signals sent to or received from the user equipment passes, so as to allocate appropriate communication resources for the user equipment.

FIG. 3 shows a flowchart of a method for reporting device capability information according to an embodiment of the present disclosure. As shown in FIG. 3, the method can be performed by a smart repeater and includes the following step S301.

At step S301, device capability information is sent to a network device, where the device capability information indicates a supported frequency band and/or a supported frequency band combination.

The smart repeater can report device capability information including the supported frequency band(s) and/or supported frequency band combination(s) to the network device, where details regarding the supported frequency band and supported frequency band combination can be found in the detailed description above with respect to the embodiment described in FIG. 2.

In some examples, the supported (frequency) bands and/or the supported (frequency) band combinations may be indicated by an NR (frequency) band number, In some examples the parameter may be defined for each (per) band, and In some examples the parameter may be mandatory to report. In some examples, this parameter may be independent of FDD/TDD. In some examples, this parameter does not need to distinguish between FR1 band and FR2 band, that is, it is equally effective for FR1 band and FR2 band.

According to the method of reporting device capability information of embodiments of the present disclosure, the smart repeater reports device capability information indicating its supported frequency band and/or supported frequency band combination to the network device, so that the network device, when allocating communication resources for user equipment, can sufficiently consider the supported frequency band and/or supported frequency band combination of the smart repeater through which signals sent to or received from the user equipment passes, so as to allocate appropriate communication resources for the user equipment.

FIG. 4 shows a flowchart of a method for reporting device capability information according to an embodiment of the present disclosure. As shown in FIG. 4, the method can be performed by a smart repeater and includes the following step S401.

At step S401, device capability information is sent to a network device, where the device capability information indicates a supported maximum number of contiguous carrier aggregations/multi-carriers and/or a supported maximum cumulative bandwidth of contiguous carrier aggregations/multi-carriers.

The smart repeater can report device capability information including the supported maximum number of contiguous carrier aggregations/multi-carriers and/or the supported maximum cumulative bandwidth of contiguous carrier aggregations/multi-carriers to the network device, where details regarding the supported maximum number of contiguous carrier aggregations/multi-carriers and/or a supported maximum cumulative bandwidth of contiguous carrier aggregations/multi-carriers can be found in the detailed description above with respect to the embodiment described in FIG. 2.

In some examples, the number of maximum contiguous carrier aggregations/multi-carriers that can be supported and/or the cumulative bandwidth of maximum contiguous carrier aggregations/multi-carriers that can be supported may be defined for per band. In some examples, this parameter may not be mandatory to report. In some examples, this parameter may be independent of FDD/TDD. In some examples, this parameter does not need to distinguish between FR1 frequency band and FR2 frequency band.

According to the method of reporting device capability information of embodiments of the present disclosure, the smart repeater reports device capability information indicating its supported maximum number of contiguous carrier aggregations/multi-carriers and/or supported maximum cumulative bandwidth of contiguous carrier aggregations/multi-carriers to the network device, so that the network device, when allocating communication resources for user equipment, can sufficiently consider the supported maximum number of contiguous carrier aggregations/multi-carriers and/or the supported maximum cumulative bandwidth of contiguous carrier aggregations/multi-carriers of the smart repeater through which signals sent to or received from the user equipment passes, so as to allocate appropriate communication resources for the user equipment.

FIG. 5 shows a flowchart of a method for reporting device capability information according to an embodiment of the present disclosure. As shown in FIG. 5, the method can be performed by a smart repeater and includes the following step S501.

At step S501, device capability information is sent to a network device, where the device capability information indicates a supported frequency separation between non-contiguous carrier aggregations.

The smart repeater can report device capability information including the supported frequency separation between non-contiguous carrier aggregations to the network device, where details regarding the supported frequency separation between non-contiguous carrier aggregations can be found in the detailed description above with respect to the embodiment described in FIG. 2.

In some examples, the supported frequency separation between non-contiguous carrier aggregations can be defined for each band in per band combination or for per feature set. In some examples, the parameter may be not mandatory to report or conditionally mandatory to report. In some examples, this parameter may be independent of FDD/TDD. In some examples, this parameter needs to distinguish between FR1 frequency band and FR2 frequency band.

According to the method of reporting device capability information of embodiments of the present disclosure, the smart repeater reports device capability information indicating its supported frequency separation between non-contiguous carrier aggregations to the network device, so that the network device, when allocating communication resources for user equipment, can sufficiently consider the supported frequency separation between non-contiguous carrier aggregations of the smart repeater through which signals sent to or received from the user equipment passes, so as to allocate appropriate communication resources for the user equipment.

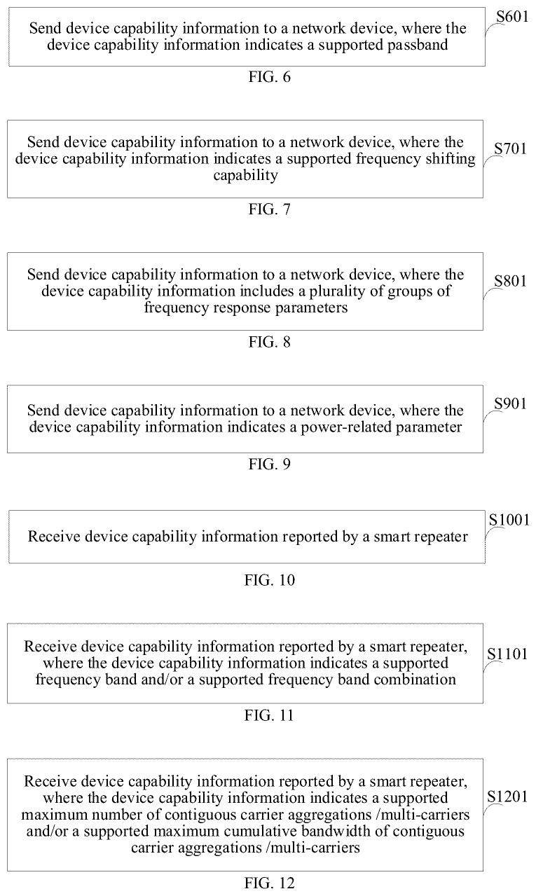

FIG. 6 shows a flowchart of a method for reporting device capability information according to an embodiment of the present disclosure. As shown in FIG. 6, the method can be performed by a smart repeater and includes the following step S601.

At step S601, device capability information is sent to a network device, where the device capability information indicates a supported passband.

The smart repeater can report device capability information including the supported passband to the network device, where details regarding the supported passband can be found in the detailed description above with respect to the embodiment described in FIG. 2.

In some examples, the supported passband can be defined for each band in per band combination or for per feature set. In some examples, the parameter may be not mandatory to report or conditionally mandatory to report. In some examples, this parameter may be independent of FDD/TDD. In some examples, this parameter does not need to distinguish between FR1 frequency band and FR2 frequency band.

According to the method of reporting device capability information of embodiments of the present disclosure, the smart repeater reports device capability information indicating its supported passband to the network device, so that the network device, when allocating communication resources for user equipment, can sufficiently consider the supported passband of the smart repeater through which signals sent to or received from the user equipment passes, so as to allocate appropriate communication resources for the user equipment.

FIG. 7 shows a flowchart of a method for reporting device capability information according to an embodiment of the present disclosure. As shown in FIG. 7, the method can be performed by a smart repeater and includes the following step S701.

At step S701, device capability information is sent to a network device, where the device capability information indicates a supported frequency shifting capability.

The smart repeater can report device capability information including the supported frequency shifting capability to the network device, where details regarding the supported frequency shifting capability can be found in the detailed description above with respect to the embodiment described in FIG. 2.

In some examples, the supported frequency shifting capability can be defined for each frequency band or each frequency range in per band combination. In some examples, the parameter may be not mandatory to report or conditionally mandatory to report. In some examples, this parameter may be independent of FDD/TDD. In some examples, this parameter does not need to distinguish between FR1 frequency band and FR2 frequency band.

For example, the supported frequency shifting capability includes one or more of the following pieces of information: information indicating that the smart repeater performs frequency modulation in-band or out-of-band, which can be indicated by in (in-band) or out (out-of-band), where “in” indicates that the smart repeater can only perform frequency modulation and amplification on an input signal in the same frequency band, while “out” indicates that the smart repeater can perform frequency modulation and amplification on an input signal in different frequency bands; information indicating an adjustable frequency range of repeater, such as a maximum up-chirp(up-conversion) and a maximum down-chirp(down-conversion); and information indicating a frequency modulation step size of the smart repeater, for example, represented by a fixed value of S MHz.

According to the method of reporting device capability information of embodiments of the present disclosure, the smart repeater reports device capability information indicating its supported frequency shifting capability to the network device, so that the network device, when allocating communication resources for user equipment, can sufficiently consider the supported frequency shifting capability of the smart repeater through which signals sent to or received from the user equipment passes, so as to allocate appropriate communication resources for the user equipment.

FIG. 8 shows a flowchart of a method for reporting device capability information according to an embodiment of the present disclosure. As shown in FIG. 8, the method can be performed by a smart repeater and includes the following step S801.

At step S801, device capability information is sent to a network device, where the device capability information includes a plurality of groups of frequency response parameters, and each group of frequency response parameters can be at least one of the following frequency-related parameters: a supported frequency band; a supported frequency band combination; a supported maximum number of contiguous carrier aggregations; a supported maximum cumulative bandwidth of contiguous carrier aggregations; a supported frequency separation between non-contiguous carrier aggregations; a supported passband; or a supported frequency shifting capability.

For details of frequency response parameters, reference can be made to the detailed description of the embodiment described above with respect to FIG. 2.

In some embodiments, the smart repeater can report two groups of frequency response parameters to the network device, where one group of frequency response parameters is related to the repeater part of the smart repeater, and the other group of frequency response parameters is related to the mobile terminal part of the smart repeater. For the mobile terminal part, there is no need to report the supported frequency shifting capability and supported passband.

FIG. 9 shows a flowchart of a method for reporting device capability information according to an embodiment of the present disclosure. As shown in FIG. 9, the method can be performed by a smart repeater and includes the following step S901.

At step S901, device capability information is sent to a network device, where the device capability information indicates a power-related parameter.

The smart repeater can report device capability information including the power-related parameter(s) to the network device, where details regarding the power-related parameter can be found in the detailed description above with respect to the embodiment described in FIG. 2.

For example, in some embodiments, the smart repeater can report a group of power-related parameters to the network device, including multiple PCs, where different PCs correspond to different transmission power classes(levels).

As another example, in other embodiments, the smart repeater can report two groups of power-related parameters, where one group of power-related parameters includes a plurality of PCs related to the repeater part of the smart repeater, and the other group of power-related parameters includes a plurality of PCs related to the mobile terminal part of the smart repeater.

In some embodiments, power-related parameters may be reported for different frequency bands. If the smart repeater does not report PCs for a certain frequency band, a default power can be used on the frequency band.

According to the method of reporting device capability information of embodiments of the present disclosure, the smart repeater reports device capability information indicating its power-related parameter to the network device, so that the network device, when allocating communication resources for user equipment, can sufficiently consider the power-related parameter of the smart repeater through which signals sent to or received from the user equipment passes, so as to allocate appropriate communication resources for the user equipment.

It can be understood by those skilled in the art that the technical solutions in FIGS. 3-10 can be implemented alone or together with any one of the other technical solutions in the embodiments of the present disclosure, and the embodiments of the present disclosure do not limit this.

FIG. 10 shows a flowchart of a method for acquiring device capability information according to an embodiment of the present disclosure. As shown in FIG. 10, the method can be performed by a network device and includes the following step S1001.

S1001, device capability information reported by a smart repeater is received, where the device capability information indicates frequency response capability of the smart repeater and includes one or more groups of frequency response parameters.

In the present disclosure, the network device can receive the device capability information reported by the smart repeater, so that the network device, when allocating communication resources for a user equipment, can consider device capability information of a smart repeater corresponding to the user equipment, so as to allocate appropriate communication resources for the user equipment.

The device capability information of the smart repeater is used to indicate the frequency response capability of the smart repeater, and may include at least one group of frequency response parameters. The frequency response capability can also reflect a carrier aggregation capability of smart repeater.

In some embodiments, each of the groups of frequency response parameters includes at least one of the following frequency-related parameters: a supported frequency band; a supported frequency band combination; a supported maximum number of contiguous carrier aggregations; a supported maximum cumulative bandwidth of contiguous carrier aggregations; a supported frequency separation between non-contiguous carrier aggregations; a supported passband; or a supported frequency shifting capability.

In some embodiments, the frequency-related parameter is indicated by one or more fixed values or range values.

For example, the smart repeater can report a group of frequency response parameters to the network device, including one or more of the following frequency-related parameters.

### 1. A Supported Frequency Band

The supported frequency band can be indicated by, for example, an NR frequency band number, and this parameter can be defined for each frequency band (per band), and this parameter can be mandatory to report.

The supported frequency band can be indicated by one or more fixed values, such as (frequency) band numbers 1, 11, 21. Or, the supported frequency band can also be indicated by one or more range values, such as all frequency bands with band numbers less than 20, and all frequency bands with band numbers greater than 30 but less than 40.

### 2. A Supported Frequency Band Combination

Similar to the supported frequency band, this parameter can be defined for per band, and this parameter can be mandatory to report.

The supported frequency band combination can also be indicated by one or more range values, such as frequency band combination 1, frequency band combination 2 and frequency band combination 4. Where frequency band combination 1 indicates {frequency band 1-frequency band 5}, frequency band combination 2 indicates {frequency band 11-frequency band 15}, and frequency band combination 4 indicates {frequency band 31-frequency band 35}.

### 3. A Supported Maximum Number of Contiguous Carrier Aggregations

This parameter can be defined for per band, indicating a maximum carrier aggregation number that can be continuously scheduled on per band, and this parameter may not be mandatory to report.

The supported maximum number of contiguous carrier aggregations can be indicated by a fixed value, for example, 8.

### 4. A Supported Maximum Cumulative Bandwidth of Contiguous Carrier Aggregations

Similar to the supported maximum number of contiguous carrier aggregations, this parameter can be defined for per band, indicating a maximum carrier aggregation bandwidth that can be continuously scheduled on per band, and this parameter may not be mandatory to report.

The supported maximum cumulative bandwidth of carrier aggregations can be indicated by a fixed value, such as 800 MHz. Or, the supported maximum cumulative bandwidth of carrier aggregations can be indicated by a range value. For example, a number of different classes can be predefined, for example, class A indicates 0-400 MHz, class B indicates 400 MHz-800 MHz, and class C indicates 800 MHz-1200 MHz. When the supported cumulative bandwidth of maximum carrier aggregations is indicated by class B, it indicates that the supported maximum cumulative bandwidth of carrier aggregations is 800 MHz, and a base station can realize continuous carrier scheduling between 400 MHz and 800 MHz.

### 5. A Supported Frequency Separation Between Non-Contiguous Carrier Aggregations

This parameter can be defined for each frequency band in each frequency band combination (per band combination) or for per feature set, and the parameter can be not mandatory to report or conditionally mandatory to report (i.e., mandatory to report under certain conditions), e.g., the smart repeater can include mobile terminal part and repeater part, and for the repeater part of the smart repeater, the parameter is mandatory to report. In addition, this parameter can distinguish FR1 frequency band and FR2 frequency band, where FR1 frequency band and FR2 frequency band are two main frequencies used in 5G networks. A frequency range of FR1 band is 450 MHz-6 GHz, also known as a band below 6 GHz, while a frequency range of FR2 band is 24.25 GHz-52.6 GHz, which is usually named as millimeter wave. For example, for the FR1 frequency band, this parameter can be indicated by a range value, e.g., a plurality of different classes can be predefined, for example, class 1 indicates that a frequency separation between non-contiguous carrier aggregations is less than or equal to 100 MHz, class 2 indicates that a frequency separation between non-contiguous carrier aggregations is more than 100 MHz and less than or equal to 200 MHz, class 3 indicates that a frequency separation between non-contiguous carrier aggregations is greater than 200 MHz and less than or equal to 600 MHz, and when a supported frequency separation between non-contiguous carrier aggregations is indicated by class 3, it indicates that the supported frequency separation between non-contiguous carrier aggregations is greater than 200 MHz and less than or equal to 600 MHz. For another example, for the FR2 frequency band, this parameter can be indicated by a fixed value, which refers to a frequency separation between a lower frequency edge of a carrier unit corresponding to a minimum frequency and an upper frequency edge of a carrier unit corresponding to a maximum frequency in the non-contiguous carrier aggregation, e.g., 2 GHz.

### 6. A Supported Passband

This parameter can be defined for each frequency band in each frequency band combination (per band combination) or for per feature set, and the parameter can be not mandatory to report or conditionally mandatory to report (i.e., mandatory to report under certain conditions), e.g., for the repeater part of the smart repeater, the parameter is mandatory to report.

The supported passband (range) may be indicated by one or more range values, for example, passband 1, passband 2. The passband 1 indicates a frequency band range of 400 MHz-800 MHz, and the passband 2 indicates a frequency band range of 2.5 GHz-4.3 GHz.

### 7. A Supported Frequency Shifting Capability

This parameter can be defined for each frequency band or each frequency range in per band combination, and the parameter can be not mandatory to report or conditionally mandatory to report (i.e., mandatory to report under certain conditions), e.g., for the repeater part of the smart repeater, the parameter is mandatory to report.

In some embodiments, the supported frequency shifting capability includes at least one of the following: information indicating that the smart repeater performs frequency modulation in-band or out-of-band; information indicating an adjustable frequency range of the smart repeater; or information indicating a frequency modulation step size of the smart repeater.

For example, the information indicating that the smart repeater performs frequency modulation in-band or out-of-band can be indicated by in-band frequency modulation or out-of-band frequency modulation, where in-band frequency modulation indicates that the smart repeater can only perform frequency modulation and amplification on an input signal in the same frequency band, while out-of-band frequency modulation indicates that the smart repeater can perform frequency modulation and amplification on an input signal in different frequency bands.

The information indicating the adjustable frequency range of smart repeater can be represented by one or more fixed values, such as +m MHz and −n MHz, which means that a maximum up-chirp is m MHz and a maximum down-chirp is n MHz, that is, an adjustable frequency range is [f0−n, f0+m], where f0 is a frequency to be adjusted. For another example, a frequency modulation step size can be predefined as S MHz, and the information indicating the adjustable frequency modulation range of smart repeater can be indicated by integers n1 and n2, which means that an adjustable frequency modulation range is [f0+n1*S, f0+n2*S]. Or, the information indicating the adjustable frequency range of the smart repeater can also be represented by a range value, such as m1-m2 MHz, which means that the adjustable frequency range is [f0+m1, f0+m2].

The information indicating the frequency modulation step size of the smart repeater may be indicated by a fixed value, for example, 200 MHz.

In some embodiments, each of the groups of frequency response parameters further includes one or more power-related parameters, and the one or more power-related parameters include at least one of following parameters: a supported transmission power class; a supported maximum transmission power value; a supported target receiving power value; or a supported target receiving power class.

In addition to the above-mentioned frequency-related parameters, the smart repeater can further report power-related parameters to the network device.

For example, the smart repeater may report a group of frequency response parameters to the network device, which may include one or more of the following power-related parameters in addition to the above-mentioned frequency-related parameters.

### 1. A Supported Transmission Power Class

This parameter can be defined for per band, and it may not be mandatory to report. This parameter can distinguish between FR1 (frequency) band and FR2 (frequency) band.

For example, for the FR1 frequency band, the supported transmission power class can be indicated by power classes (PC) such as PC2 and PC3, where PC2 indicates a maximum transmission power is 26 dBm, and PC3 indicates a maximum transmission power is 23 dBm. For the FR2 frequency band, the supported transmission power class can be indicated by power classes such as PC1, PC2, PC3 and PC4. Considering that high frequency bands will perform beamforming to improve directional power, each PC can further contain parameters related to beamforming, e.g., min peak equivalent isotropically radiated power (min peak EIRP), maximum equivalent isotropically radiated power (Max EIRP) and Spherical Coverage, such as min peak EIRP=22 dB, Max EIRP=26 dB and Spherical Coverage=11 dB.

### 2. A Supported Maximum Transmission Power Value

The maximum supported maximum transmission power value can be indicated by a fixed value, for example, 23 dBm. It can also be indicated by a group of transmission power values, such as min peak EIRP=22 dB, Max EIRP=26 dB, and Spherical Coverage=11 dB.

### 3. A Supported Target Receiving Power Value

This parameter can be not mandatory to report or conditionally mandatory to report (i.e., mandatory to report under certain conditions), e.g., for the repeater part of the smart repeater, the parameter is mandatory to report.

The supported target receiving power value can be indicated by a fixed value, such as −140 dBm, and can further be indicated by a target receiving power spectral density value, such as −140 dBm/MHz.

### 4. A Supported Target Receiving Power Class

This parameter can be not mandatory to report or conditionally mandatory to report (i.e., mandatory to report under certain conditions), e.g., for the repeater part of the smart repeater, the parameter is mandatory to report.

Similar to the supported transmission power class, the supported target receiving power class may be indicated by a predefined power class.

In some embodiments, the smart repeater may not report the frequency-related parameters to the network device. In this case, a supported transmission power value may be considered as a default power value, which may be a maximum transmission power of the smart repeater.

In some embodiments, the supported transmission power class indicates a maximum transmission power that is not greater than respective maximum transmission powers of other user equipment in a cell to which the smart repeater belongs.

In order not to cause interference to other user equipment in the cell to which the smart repeater belongs, the supported maximum transmission power value of the smart repeater should not exceed the maximum power of other user equipment in the cell.

In some embodiments, the smart repeater includes a mobile terminal part and a repeater part, and the one or more groups of frequency response parameters includes more than one group of frequency response parameters, where at least one group in the more than one group of frequency response parameters is configured for the mobile terminal part and at least another group in the more than one group of frequency response parameters is configured for the repeater part.

The smart repeater can include a mobile terminal part and a repeater part, so that the smart repeater can respectively report capability information related to the mobile terminal part and capability information related to the repeater part to the network device. For example, the smart repeater can report at least one group of frequency response parameters related to the repeater part and at least one group of frequency response parameters related to the mobile terminal part to the network device. Each group of reported frequency response parameters may include one or more of the above frequency-related parameters, and may further include one or more of the above power-related parameters. For the mobile terminal part, there is no need to report the supported frequency shifting capability and supported passband.

According to the method of acquiring device capability information of embodiments of the present disclosure, the network device receives device capability information indicating the smart repeater's frequency response capability sent by the smart repeater, so that the network device, when allocating communication resources for user equipment, can sufficiently consider the frequency response capability of the smart repeater through which signals sent to or received from the user equipment passes, so as to allocate appropriate communication resources for the user equipment.

FIG. 11 shows a flowchart of a method for acquiring device capability information according to an embodiment of the present disclosure. As shown in FIG. 11, the method can be performed by a network device and includes the following step S1101.

At step S1101, device capability information sent by a smart repeater is received, where the device capability information indicates a supported frequency band and/or a supported frequency band combination.

The smart repeater can report device capability information including the supported frequency band(s) and/or supported frequency band combination(s) to the network device, where details regarding the supported frequency band and supported frequency band combination can be found in the detailed description above with respect to the embodiment described in FIG. 2.

In some examples, the supported (frequency) bands and/or the supported (frequency) band combinations may be indicated by an NR (frequency) band number, In some examples the parameter may be defined for each (per) band, and In some examples the parameter may be mandatory to report. In some examples, this parameter may be independent of FDD/TDD. In some examples, this parameter does not need to distinguish between FR1 band and FR2 band, that is, it is equally effective for FR1 band and FR2 band.

According to the method of acquiring device capability information of embodiments of the present disclosure, the network device receives device capability information indicating the smart repeater's supported frequency band and/or supported frequency band combination sent by the smart repeater, so that the network device, when allocating communication resources for user equipment, can sufficiently consider the supported frequency band and/or supported frequency band combination of the smart repeater through which signals sent to or received from the user equipment passes, so as to allocate appropriate communication resources for the user equipment.

FIG. 12 shows a flowchart of a method for acquiring device capability information according to an embodiment of the present disclosure. As shown in FIG. 12, the method can be performed by a network device and includes the following step S1201.

At step S1201, device capability information sent by a smart repeater is received, where the device capability information indicates a supported maximum number of contiguous carrier aggregations/multi-carriers and/or a supported maximum cumulative bandwidth of contiguous carrier aggregations/multi-carriers.

The smart repeater can report device capability information including the supported maximum number of contiguous carrier aggregations/multi-carriers and/or the supported maximum cumulative bandwidth of contiguous carrier aggregations/multi-carriers to the network device, where details regarding the supported maximum number of contiguous carrier aggregations/multi-carriers and/or the supported maximum cumulative bandwidth of contiguous carrier aggregations/multi-carriers can be found in the detailed description above with respect to the embodiment described in FIG. 2.

In some examples, the number of maximum contiguous carrier aggregations/multi-carriers that can be supported and/or the cumulative bandwidth of maximum contiguous carrier aggregations/multi-carriers that can be supported may be defined for per band. In some examples, this parameter may not be mandatory to report. In some examples, this parameter may be independent of FDD/TDD. In some examples, this parameter does not need to distinguish between FR1 frequency band and FR2 frequency band.

According to the method of acquiring device capability information of embodiments of the present disclosure, the network device receives device capability information indicating the smart repeater's supported maximum number of contiguous carrier aggregations/multi-carriers and/or supported maximum cumulative bandwidth of contiguous carrier aggregations/multi-carriers sent by the smart repeater, so that the network device, when allocating communication resources for user equipment, can sufficiently consider the supported maximum number of contiguous carrier aggregations/multi-carriers and/or the supported maximum cumulative bandwidth of contiguous carrier aggregations/multi-carriers of the smart repeater through which signals sent to or received from the user equipment passes, so as to allocate appropriate communication resources for the user equipment.

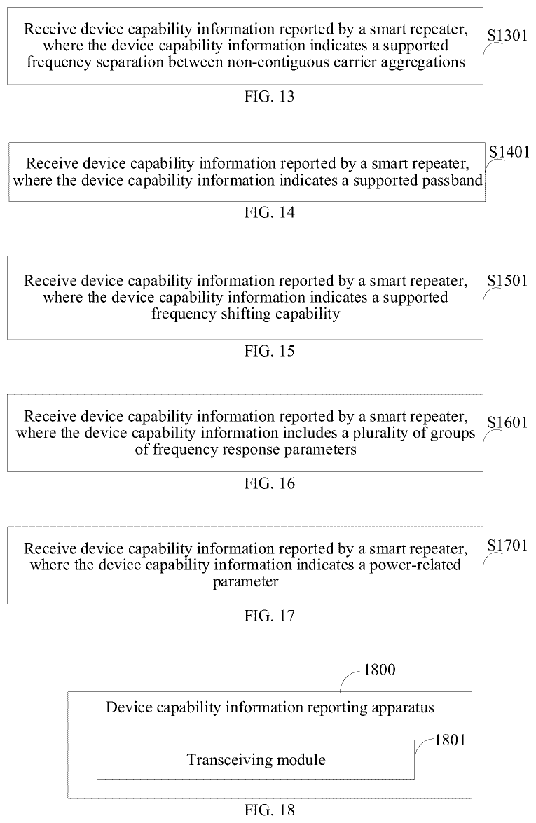

FIG. 13 shows a flowchart of a method for acquiring device capability information according to an embodiment of the present disclosure. As shown in FIG. 13, the method can be performed by a network device and includes the following step S1301.

At step S1301, device capability information sent by a smart repeater is received, where the device capability information indicates a supported frequency separation between non-contiguous carrier aggregations.

The smart repeater can report device capability information including the supported frequency separation between non-contiguous carrier aggregations to the network device, where details regarding the supported frequency separation between non-contiguous carrier aggregations can be found in the detailed description above with respect to the embodiment described in FIG. 2.

In some examples, the supported frequency separation between non-contiguous carrier aggregations can be defined for each band in per band combination or for per feature set. In some examples, the parameter may be not mandatory to report or conditionally mandatory to report. In some examples, this parameter may be independent of FDD/TDD. In some examples, this parameter needs to distinguish between FR1 frequency band and FR2 frequency band.

According to the method of acquiring device capability information of embodiments of the present disclosure, the network device receives device capability information indicating the smart repeater's supported frequency separation between non-contiguous carrier aggregations sent by the smart repeater, so that the network device, when allocating communication resources for user equipment, can sufficiently consider the supported frequency separation between non-contiguous carrier aggregations of the smart repeater through which signals sent to or received from the user equipment passes, so as to allocate appropriate communication resources for the user equipment.

FIG. 14 shows a flowchart of a method for acquiring device capability information according to an embodiment of the present disclosure. As shown in FIG. 14, the method can be performed by a network device and includes the following step S1401.

At step S1401, device capability information sent by a smart repeater is received, where the device capability information indicates a supported passband.

The smart repeater can report device capability information including the supported passband to the network device, where details regarding the supported passband can be found in the detailed description above with respect to the embodiment described in FIG. 2.

In some examples, the supported passband can be defined for each band in per band combination or for per feature set. In some examples, the parameter may be not mandatory to report or conditionally mandatory to report. In some examples, this parameter may be independent of FDD/TDD. In some examples, this parameter does not need to distinguish between FR1 frequency band and FR2 frequency band.

According to the method of acquiring device capability information of embodiments of the present disclosure, the network device receives device capability information indicating the smart repeater's supported passband sent by the smart repeater, so that the network device, when allocating communication resources for user equipment, can sufficiently consider the supported passband of the smart repeater through which signals sent to or received from the user equipment passes, so as to allocate appropriate communication resources for the user equipment.

FIG. 15 shows a flowchart of a method for acquiring device capability information according to an embodiment of the present disclosure. As shown in FIG. 15, the method can be performed by a network device and includes the following step S1501.

At step S1501, device capability information sent by a smart repeater is received, where the device capability information indicates a supported frequency shifting capability.

The smart repeater can report device capability information including the supported frequency shifting capability to the network device, where details regarding the supported frequency shifting capability can be found in the detailed description above with respect to the embodiment described in FIG. 2.

In some examples, the supported frequency shifting capability can be defined for each frequency band or each frequency range in per band combination. In some examples, the parameter may be not mandatory to report or conditionally mandatory to report. In some examples, this parameter may be independent of FDD/TDD. In some examples, this parameter does not need to distinguish between FR1 frequency band and FR2 frequency band.

For example, the supported frequency shifting capability includes one or more of the following pieces of information: information indicating that the smart repeater performs frequency modulation in-band or out-of-band, which can be indicated by in (in-band) or out (out-of-band), where “in” indicates that the smart repeater can only perform frequency modulation and amplification on an input signal in the same frequency band, while “out” indicates that the smart repeater can perform frequency modulation and amplification on an input signal in different frequency bands; information indicating an adjustable frequency range of repeater, such as a maximum up-chirp(up-conversion) and a maximum down-chirp(down-conversion); and information indicating a frequency modulation step size of the smart repeater, for example, represented by a fixed value of S MHz.

According to the method of acquiring device capability information of embodiments of the present disclosure, the network device receives device capability information indicating the smart repeater's supported frequency shifting capability sent by the smart repeater, so that the network device, when allocating communication resources for user equipment, can sufficiently consider the supported frequency shifting capability of the smart repeater through which signals sent to or received from the user equipment passes, so as to allocate appropriate communication resources for the user equipment.

FIG. 16 shows a flowchart of a method for acquiring device capability information according to an embodiment of the present disclosure. As shown in FIG. 16, the method can be performed by a network device and includes the following step S1601.

At step S1601, device capability information sent by a smart repeater is received, where the device capability information includes a plurality of groups of frequency response parameters, and each group of frequency response parameters can be at least one of the following frequency-related parameters: a supported frequency band; a supported frequency band combination; a supported maximum number of contiguous carrier aggregations; a supported maximum cumulative bandwidth of contiguous carrier aggregations; a supported frequency separation between non-contiguous carrier aggregations; a supported passband; or a supported frequency shifting capability.

For details of frequency response parameters, reference can be made to the detailed description of the embodiment described above with respect to FIG. 2.

In some embodiments, the smart repeater can report two groups of frequency response parameters to the network device, where one group of frequency response parameters is related to the repeater part of the smart repeater, and the other group of frequency response parameters is related to the mobile terminal part of the smart repeater. For the mobile terminal part, there is no need to report the supported frequency shifting capability and supported passband.

FIG. 17 shows a flowchart of a method for acquiring device capability information according to an embodiment of the present disclosure. As shown in FIG. 17, the method can be performed by a network device and includes the following step S1701.

At step S1701, device capability information sent by a smart repeater is received, where the device capability information indicates a power-related parameter.

The smart repeater can report device capability information including the power-related parameter(s) to the network device, where details regarding the power-related parameter can be found in the detailed description above with respect to the embodiment described in FIG. 2.

For example, in some embodiments, the smart repeater can report a group of power-related parameters to the network device, including multiple PCs, where different PCs correspond to different transmission power classes(levels).

As another example, in other embodiments, the smart repeater can report two groups of power-related parameters, where one group of power-related parameters includes a plurality of PCs related to the repeater part of the smart repeater, and the other group of power-related parameters includes a plurality of PCs related to the mobile terminal part of the smart repeater.

In some embodiments, power-related parameters may be reported for different frequency bands. If the smart repeater does not report PCs for a certain frequency band, a default power can be used on the frequency band.

According to the method of acquiring device capability information of embodiments of the present disclosure, the network device receives device capability information indicating the smart repeater's power-related parameter sent by the smart repeater, so that the network device, when allocating communication resources for user equipment, can sufficiently consider the power-related parameter of the smart repeater through which signals sent to or received from the user equipment passes, so as to allocate appropriate communication resources for the user equipment.

It can be understood by those skilled in the art that the technical solutions in FIGS. 11-17 can be implemented alone or together with any one of the other technical solutions in the embodiments of the present disclosure, and the embodiments of the present disclosure do not limit this.

In the above embodiments provided by the present disclosure, the methods provided by the embodiments of the present disclosure are introduced from the perspectives of network device and user equipment respectively. In order to realize each of the functions in the method provided in the above embodiments of the present disclosure, the network device and the user equipment may include a hardware structure, a software module, and the above functions are realized in the form of hardware structure, software module, or hardware structure plus software module. One of the described functions can be implemented in a hardware structure, a software module, or a combination of hardware structure and software module.

Corresponding to the device capability information reporting methods provided by the above-mentioned embodiments, the present disclosure further provides the device capability information reporting apparatuses. Since the device capability information reporting apparatuses provided in embodiments of the present disclosure corresponding to the device capability information reporting apparatuses provided by the above-mentioned embodiments, the implementations in the device capability information reporting methods are also applicable to the device capability information reporting apparatuses provided by the embodiments of the present disclosure, and will not be described in detail in this embodiment.

FIG. 18 is a schematic structural diagram of an apparatus 1800 for reporting device capability information according to an embodiment of the present disclosure.

As shown in FIG. 18, the apparatus 1800 may include a transceiving module 1801.

The transceiver module 1801 is configured to send device capability information to a network device, where the device capability information indicates frequency response capability of the smart repeater and includes one or more groups of frequency response parameters.

According to the apparatus for reporting device capability information of embodiments of the present disclosure, the smart repeater reports device capability information indicating its frequency response capability to the network device, so that the network device, when allocating communication resources for user equipment, can sufficiently consider the frequency response capability of the smart repeater through which signals sent to or received from the user equipment passes, so as to allocate appropriate communication resources for the user equipment.

In some embodiments, each of the groups of frequency response parameters includes at least one of the following frequency-related parameters: a supported frequency band; a supported frequency band combination; a supported maximum number of contiguous carrier aggregations; a supported maximum cumulative bandwidth of contiguous carrier aggregations; a supported frequency separation between non-contiguous carrier aggregations; a supported passband; or a supported frequency shifting capability.

In some embodiments, the frequency-related parameter is indicated by one or more fixed values or range values.

In some embodiments, the supported frequency shifting capability includes at least one of the following: information indicating that the smart repeater performs frequency modulation in-band or out-of-band; information indicating an adjustable frequency range of the smart repeater; or information indicating a frequency modulation step size of the smart repeater.

In some embodiments, each of the groups of frequency response parameters further includes one or more power-related parameters, and the one or more power-related parameters include at least one of following parameters: a supported transmission power class; a supported maximum transmission power value; a supported target receiving power value; or a supported target receiving power class.

In some embodiments, the supported transmission power class indicates a maximum transmission power that is not greater than respective maximum transmission powers of other user equipment in a cell to which the smart repeater belongs.

In some embodiments, the smart repeater includes a mobile terminal part and a repeater part, and the one or more groups of frequency response parameters includes more than one group of frequency response parameters, where at least one group in the more than one group of frequency response parameters is configured for the mobile terminal part and at least another group in the more than one group of frequency response parameters is configured for the repeater part.

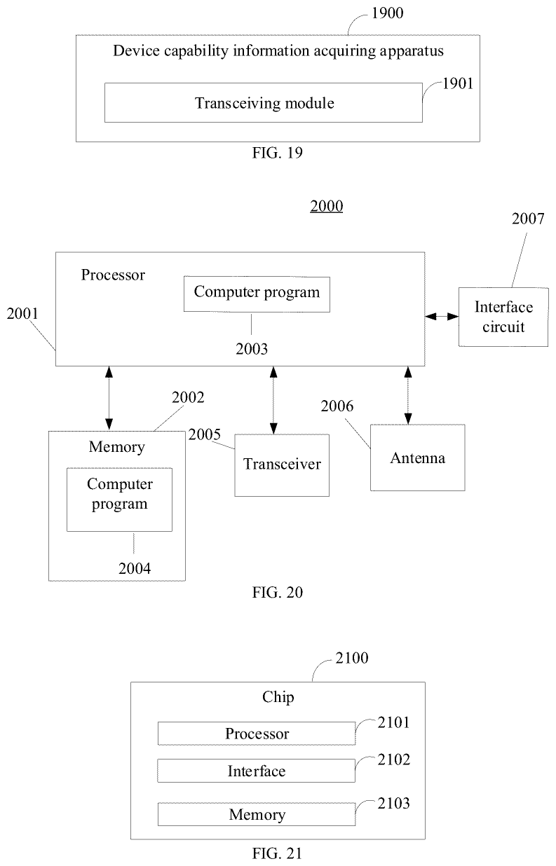

FIG. 19 is a schematic structural diagram of an apparatus 1900 for acquiring device capability information according to an embodiment of the present disclosure.

As shown in FIG. 19, the apparatus 1900 may include a transceiving module 1901.

The transceiving module 1901 can be configured to receive device capability information reported by a smart repeater, where the device capability information indicates frequency response capability of the smart repeater and includes one or more groups of frequency response parameters.

According to the apparatus for acquiring device capability information of embodiments of the present disclosure, device capability information indicating the smart repeater's frequency response capability reported by the smart repeater is received, so that the network device, when allocating communication resources for user equipment, can sufficiently consider the frequency response capability of the smart repeater through which signals sent to or received from the user equipment passes, so as to allocate appropriate communication resources for the user equipment.

In some embodiments, each of the groups of frequency response parameters includes at least one of the following frequency-related parameters: a supported frequency band; a supported frequency band combination; a supported maximum number of contiguous carrier aggregations; a supported maximum cumulative bandwidth of contiguous carrier aggregations; a supported frequency separation between non-contiguous carrier aggregations; a supported passband; or a supported frequency shifting capability.

In some embodiments, the frequency-related parameter is indicated by one or more fixed values or range values.

In some embodiments, the supported frequency shifting capability includes at least one of the following: information indicating that the smart repeater performs frequency modulation in-band or out-of-band; information indicating an adjustable frequency range of the smart repeater; or information indicating a frequency modulation step size of the smart repeater.

In some embodiments, each of the groups of frequency response parameters further includes one or more power-related parameters, and the one or more power-related parameters include at least one of following parameters: a supported transmission power class; a supported maximum transmission power value; a supported target receiving power value; or a supported target receiving power class.

In some embodiments, the supported transmission power class indicates a maximum transmission power that is not greater than respective maximum transmission powers of other user equipment in a cell to which the smart repeater belongs.

In some embodiments, the smart repeater includes a mobile terminal part and a repeater part, and the one or more groups of frequency response parameters includes more than one group of frequency response parameters, where at least one group in the more than one group of frequency response parameters is configured for the mobile terminal part and at least another group in the more than one group of frequency response parameters is configured for the repeater part.

Referring to FIG. 20, FIG. 20 is a schematic structural diagram of a communication apparatus 2000 according to an embodiment of the present disclosure. The communication apparatus 2000 may be a network device, a user equipment, a chip, a chip system, or a processor that supports network device to implement the above method, or a chip, a chip system, or a processor that supports user equipment to implement the above method. The apparatus can be configured to realize the methods described in the above-mentioned method embodiments, for details, please refer to the description in the above-mentioned method embodiments.

The communication apparatus 2000 may include one or more processors 2001. The processor 2001 may be a general purpose processor or a specialized processor, etc. Such as a baseband processor or a central processing unit. The baseband processor can be configured to process communication protocols as well as communication data, and the central processor can be configured to control a communication apparatus (e.g., a base station, a baseband chip, a terminal device, a terminal device chip, a DU or a CU, etc.), execute a computer program, and process data from a computer program.

Optionally, the communication apparatus 2000 may further include one or more memories 2002, on which a computer program 2004 may be stored, and the processor 2001 executes the computer program 2004, so that the communication apparatus 2000 can execute the methods described in the above method embodiments. Optionally, data can also be stored in the memory 2002. The communication apparatus 2000 and the memory 2002 may be set separately or integrated together.

Optionally, the communication apparatus 2000 may further include a transceiver 2005 and an antenna 2006. The transceiver 2005 can be called a transceiver unit, a transceiver machine, a transceiver circuit, etc., and is configured to realize transceiver functions. The transceiver 2005 may include a receiver and a transmitter, and the receiver may be called a receiving machine or a receiving circuit, etc., and is configured to realize receiving functions. The transmitter can be called a transmitting machine or a transmitting circuit, etc., and is configured to realize transmitting functions.

Optionally, the communication apparatus 2000 may further include one or more interface circuits 2007. The interface circuit 2007 is configured to receive code instructions and transmit them to the processor 2001. The processor 2001 executes the code instructions to cause the communication apparatus 2000 to perform the methods described in the above method embodiments.

The communication apparatus 2000 is a user equipment: the transceiver 2005 is configured to execute step S201 in FIG. 2.

The communication apparatus 2000 is a network device: the transceiver 2005 is configured to execute step S1001 in FIG. 10.

In an implementation, the processor 2001 may include a transceiver for implementing receiving and transmitting functions. For example, the transceiver can be a transceiver circuit, an interface, or an interface circuit. The transceiver circuits, interfaces or interface circuits for receiving and transmitting functions can be separated or integrated. The transceiver circuit, interface or interface circuit can be configured to read and write codes/data, or the transceiver circuit, interface or interface circuit can be configured to signal transmission or delivery.

In an implementation, the processor 2001 can store a computer program 2003, and the computer program 2003 runs on the processor 2001, which can make the communication apparatus 2000 execute the methods described in the above-mentioned method embodiments. The computer program 2003 may be solidified in the processor 2001, in which case, the processor 2001 may be implemented by hardware.

In an implementation, the communication apparatus 2000 may include a circuit, which may realize the function of transmitting or receiving or communicating in the above-mentioned method embodiments. The processor and transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver can also be manufactured by various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS(BiCMOS), silicon germanium (SiGe), gallium arsenide (GaAs), etc.

The communication apparatus described in the above embodiment may be a network device or a user equipment, but the scope of the communication apparatus described in the present disclosure is not limited thereto, and the structure of the communication apparatus may not be limited by FIG. 20. The communication apparatus may be a stand-alone device or may be part of a larger device. For example, the communication apparatus may be: (1) a stand-alone integrated circuit IC, or chip, or system or subsystem of chips; (2) a collection of ICs having one or more, optionally, the collection of ICs may also include storage components for storing data, computer programs; (3) an ASIC, such as a modem; (4) a module that can be embedded in other devices; (5) a receiver, a terminal device, an intelligent terminal device, a cellular phone, a wireless device, handset, mobile unit, a vehicle-mounted device, a network device, a cloud device, an artificial intelligence device, etc.; and (6) others, etc.

For the case that the communication apparatus can be a chip or a chip system, please refer to a structural schematic diagram of the chip 2100 shown in FIG. 21. The chip 2100 shown in FIG. 21 includes a processor 2101 and an interface 2102. The number of processors 2101 may be one or more and the number of interfaces 2102 may be more than one.

For the case where the chip 2100 is configured to realize the functions of the user equipment in the embodiments of the present disclosure: the interface 2102 is configured to perform step S201 in FIG. 2.

For the case where the chip 2100 is configured to realize the function of the network device in the embodiments of the present disclosure: the interface 2102 is configured to perform step S1001 in FIG. 10.

As further shown in FIG. 21, the chip 2100 further includes a memory 2103 for storing necessary computer programs and data.

Those skilled in the art can also understand that various illustrative logical blocks and steps listed in the embodiments of the present disclosure can be implemented by electronic hardware, computer software, or a combination of both. Whether such a function is realized in hardware or software depends on specific application and design requirements of an overall system. Those skilled in the art can use various methods to realize the described functions for each specific application, but this realization should not be understood as beyond the scope of protection of the embodiments of the present disclosure.

An embodiment of the present disclosure further provides a system for determining cell configuration, which includes a communication apparatus as a user equipment in the embodiment of FIG. 18 and a communication apparatus as a network device in the embodiment of FIG. 19, or the system includes a communication apparatus as a user equipment and a communication apparatus as a network device in the embodiment of FIG. 20.

The present disclosure further provides a readable storage medium on which instructions are stored, which, when executed by a computer, realize the functions of any of the method embodiments.

The present disclosure further provides a computer program product which, when executed by a computer, realizes the functions of any of the above method embodiments.

In the described embodiments, it can be realized in whole or in part by software, hardware, firmware or any combination thereof. When implemented using software, it may be implemented in whole or in part in the form of a computer program product. The computer program product includes one or more computer programs. When the computer program is loaded and executed on a computer, the flow or function according to the embodiments of the present disclosure is generated in whole or in part. The computer can be a general-purpose computer, a special-purpose computer, a computer network, or other programmable devices. The computer program can be stored in a computer-readable storage medium or transmitted from one computer-readable storage medium to another. For example, the computer program can be transmitted from a website, computer, server or data center to another website by wired (e.g., coaxial cable, optical fiber, digital subscriber line (DSL)) or wireless (e.g., infrared, wireless, microwave, etc.). The computer-readable storage medium may be any available medium that can be accessed by a computer or a data storage device such as a server, data center, etc. that contains one or more available media integrated. The available medium may be a magnetic medium (e.g., floppy disk, hard disk, magnetic tape), an optical medium (e.g., high-density digital video disc (DVD)), or a semiconductor medium (e.g., solid state disk (SSD)), etc.

A person of ordinary skill in the art may understand that “first”, “second”, and other various numerical numbers involved in the present disclosure are only described for the convenience of differentiation, and are not used to limit the scope of the embodiments of the present disclosure, nor do they indicate the order of precedence.

“At least one” in the present disclosure can further be described as one or more, and “a plurality” can be two, three, four or more, and the present disclosure is not limited. In the embodiment of the present disclosure, for a technical feature, the technical feature is distinguished by “first”, “second”, “third”, “A”, “B”, “C” and “D” etc. The technical features described in “first”, “second”, “third”, “A”, “B”, “C” and “D” are in no order of priority or size.

As used herein, the terms “machine-readable medium” and “computer-readable medium” refer to any computer program product, device, and/or apparatus (e.g., a magnetic disk, an optical disk, a memory, a programmable logic device (PLD)) for providing machine instructions and/or data to the programmable processor, including machine-readable media that receive machine instructions as machine-readable signals. The term “machine-readable signal” refers to any signal used to provide machine instructions and/or data to the programmable processor.

The systems and techniques described herein may be implemented in a computing system that includes a backend component (e.g., as a data server), or a computing system that includes a middleware component (e.g., an application server), or a computing system that includes a frontend component (e.g., a user computer having a graphical user interface or a web browser through which a user may interact with implementations of the systems and techniques described herein), or any combination of such backend component, middleware component, or frontend component. Components of the system can be interconnected by any form or medium of digital data communication (for example, a communication network). Examples of the communication network include: a local area network (LAN), a wide area network (WAN) and an Internet.

A computer system may include a client and a server. The client and server are generally far away from each other and usually interact through a communication network. A relationship between client and server is generated by computer programs that run on a corresponding computer and have a client-server relationship with each other.

It should be understood that steps can be reordered, added or deleted using the various forms of flow shown above. For example, the steps described in the present disclosure can be executed in parallel, in sequence, or in different orders. As long as the desired results of the technical solution disclosed in the present disclosure can be achieved, there is no restriction here.

In addition, it should be understood that various embodiments described in the present disclosure can be implemented separately or in combination with other embodiments if the solution allows.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Skilled people can use different methods to implement the described functions for each specific application, but such implementation should not be considered beyond the scope of the present disclosure.

It is clearly understood by those skilled in the field to which it belongs that, for the convenience and brevity of the description, the specific working processes of the above-described systems, apparatuses, and units can be referred to the corresponding processes in the foregoing embodiments of the method, and will not be repeated herein.

The foregoing are only specific embodiments of the present disclosure, but the scope of protection of the present disclosure is not limited thereto Any person skilled in the art who is familiar with the technical field of the present disclosure can readily think of changes or substitutions within the technical scope of the present disclosure, which should be covered within the scope of protection of the present disclosure. Therefore, the scope of protection of the present disclosure based on the scope of protection of the claims.

1. A method for reporting device capability information, performed by a smart repeater, comprising:
sending device capability information to a network device, wherein the device capability information indicates frequency response capability of the smart repeater and comprises one or more groups of frequency response parameters.

2. The method according to claim 1, wherein each of the groups of frequency response parameters comprises at least one of following frequency-related parameters:
a supported frequency band;
a supported frequency band combination;
a supported maximum number of contiguous carrier aggregations;
a supported maximum cumulative bandwidth of contiguous carrier aggregations;
a supported frequency separation between non-contiguous carrier aggregations;
a supported passband; or
a supported frequency shifting capability.

3. The method according to claim 2, wherein the frequency-related parameter is indicated by one or more fixed values or range values.

4. The method according to claim 2, wherein the supported frequency shifting capability comprises at least one of:
information indicating that the smart repeater performs frequency modulation in-band or out-of-band;
information indicating an adjustable frequency range of the smart repeater; or
information indicating a frequency modulation step size of the smart repeater.

5. The method according to claim 2, wherein each of the groups of frequency response parameters further comprises one or more power-related parameters, and the one or more power-related parameters comprise at least one of following parameters:
a supported transmission power class;
a supported maximum transmission power value;
a supported target receiving power value; or
a supported target receiving power class.

6. The method according to claim 5, wherein the supported transmission power class indicates a maximum transmission power that is not greater than respective maximum transmission powers of other user equipment in a cell to which the smart repeater belongs.

7. The method according to claim 1, wherein the smart repeater comprises a mobile terminal part and a repeater part, and the one or more groups of frequency response parameters comprises more than one group of frequency response parameters, wherein at least one group in the more than one group of frequency response parameters is configured for the mobile terminal part and at least another group in the more than one group of frequency response parameters is configured for the repeater part.

8. A method for acquiring device capability information, performed by a network device, comprising:
receiving device capability information reported by a smart repeater, wherein the device capability information indicates frequency response capability of the smart repeater and comprises one or more groups of frequency response parameters.

9. The method according to claim 8, wherein each of the groups of frequency response parameters comprises at least one of following frequency-related parameters:
a supported frequency band;
a supported frequency band combination;
a supported maximum number of contiguous carrier aggregations;
a supported maximum cumulative bandwidth of contiguous carrier aggregations;
a supported frequency separation between non-contiguous carrier aggregations;
a supported passband; or
a supported frequency shifting capability.

10. The method according to claim 9, wherein the frequency-related parameter is indicated by one or more fixed values or range values.

11. The method according to claim 9, wherein the supported frequency shifting capability comprises at least one of:
information indicating that the smart repeater performs frequency modulation in-band or out-of-band;
information indicating an adjustable frequency range of the smart repeater; or
information indicating a frequency modulation step size of the smart repeater.

12. The method according to claim 9, wherein each of the groups of frequency response parameters further comprises one or more power-related parameters, and the one or more power-related parameters comprise at least one of following parameters:
a supported transmission power class;
a supported maximum transmission power value;
a supported target receiving power value; or
a supported target receiving power class.

13. The method according to claim 12, wherein the supported transmission power class indicates a maximum transmission power that is not greater than respective maximum transmission powers of other user equipment in a cell to which the smart repeater belongs.

14. The method according to claim 8, wherein the smart repeater comprises a mobile terminal part and a repeater part, and the one or more groups of frequency response parameters comprises more than one group of frequency response parameters, wherein at least one group in the more than one group of frequency response parameters is configured for the mobile terminal part and at least another group in the more than one group of frequency response parameters is configured for the repeater part.

15-16. (canceled)

17. A communication device, comprising: a transceiver; a memory;
a processor, connected to the transceiver and the memory, respectively, and configured to control radio signal transmission and reception of the transceiver by executing computer-executable instructions on the memory, and configured to: send device capability information to a network device, wherein the device capability information indicates frequency response capability of the communication device and comprises one or more groups of frequency response parameters.

18. A communication device, comprising: a transceiver; a memory; a processor, connected to the transceiver and the memory, respectively, and configured to control radio signal transmission and reception of the transceiver by executing computer-executable instructions on the memory, and realizes the method according to claim 8.

19. A non-transitory computer readable storage medium, wherein the non-transitory computer readable storage medium stores computer executable instructions; after the computer executable instructions are executed by a processor, the processor performs the method according to claim 1.

20. A non-transitory computer readable storage medium, wherein the non-transitory computer readable storage medium stores computer executable instructions; after the computer executable instructions are executed by a processor, the processor performs the method according to claim 8.

21. The communication device according to claim 17, wherein each of the groups of frequency response parameters comprises at least one of following frequency-related parameters:
a supported frequency band;
a supported frequency band combination;
a supported maximum number of contiguous carrier aggregations;
a supported maximum cumulative bandwidth of contiguous carrier aggregations;
a supported frequency separation between non-contiguous carrier aggregations;
a supported passband; or
a supported frequency shifting capability.

22. The communication device according to claim 21, wherein the frequency-related parameter is indicated by one or more fixed values or range values.
